(19) United States
(12) Patent Application Publication
(10) Pub. No.: US 2015/0207703 A1
(43) Pub. Date: Jul. 23, 2015

(54) ABSTRACTION MODELS FOR MONITORING OF CLOUD RESOURCES

(71) Applicants: Phyllis Gallagher, Sacramento, CA (US); John M Green, Rocklin, CA (US); Jing Dong, Rocklin, CA (US); Aswini Kumar, Folsom, CA (US); Anupriya Ramraj, Granite Bay, CA (US); Travis S. Tripp, Fort Collins, CO (US); Michael Haeuptle, Rocklin, CA (US)

(72) Inventors: Phyllis Gallagher, Sacramento, CA (US); John M Green, Rocklin, CA (US); Jing Dong, Rocklin, CA (US); Aswini Kumar, Folsom, CA (US); Anupriya Ramraj, Granite Bay, CA (US); Travis S. Tripp, Fort Collins, CO (US); Michael Haeuptle, Rocklin, CA (US)

(21) Appl. No.: 14/413,563

(22) PCT Filed: Jul. 31, 2012
(86) PCT No.: PCT/US2012/048945

§ 371 Date: Jan. 8, 2015

(51) Int. Cl. H04L 12/26; H04L 12/24

(52) U.S. Cl. CPC H04L 43/04; H04L 41/12

(57) ABSTRACT

A system (100) includes a resource model (120) that includes application parameters (184) and computing resource parameters (194) that describe how an application and platform are implemented on cloud resources (110). A topology model (140) includes linkage structures (144) that link the application parameters (184) and the computing resource parameters (194) to describe a topology for the application and the platform on the cloud resources (110). A monitoring policy template (150) includes a policy (154) based on the linkage structures (144) in the topology model (140), wherein the policy (154) is to provide an abstracted specification to enable monitoring the topology for the application and the platform on the cloud resources (110).

### BACKGROUND

Cloud computing refers to the delivery of scalable and pooled computing, storage and networking capacity as a service to a network of end-recipients. The name comes from the use of clouds as an abstraction for the complex infrastructure of networks and associated hardware operative within the cloud. Cloud computing provides services for a users data, software and computation over a network, for example. Such computing capability relies on sharing of resources to achieve coherence and economies of scale similar to a utility (like the electricity grid) over a network (typically the Internet).

Managed applications deployed on resources supporting the cloud can be monitored in order ensure that services, as specified by a service level agreement (SLA) and offered by a service provider, are fulfilled according to the agreement. Conventional monitoring solutions tend to require monitoring do be performed using a single tool or subset of tools and to be deployed outside the application deployment lifecycle. For example, one system can deploy monitors with applications but is limited to one proprietary environment. In many cases, monitoring is typically limited to infrastructure with little or no application specific-monitoring while requiring custom monitoring code to be developed for each infrastructure. Worse, as systems evolve and infrastructure changes, monitoring code has to be re-developed to meet the needs of the new system which adds to overall system costs.

### BRIEF DESCRIPTION OF THE DRAWINGS

FIG. 1 illustrates an example of a system that facilitates monitoring for managed services via various abstraction models.

FIG. 2 illustrates an example system 200 that employs a model-driven architecture to provision and monitor various cloud resources.

FIG. 3 illustrates a flowchart for an example method that facilitates monitoring for managed services via abstraction models.

FIG. 4 illustrates an example system for monitoring cloud resources via abstraction models.

### DETAILED DESCRIPTION

This disclosure relates to a model that can be provided to allow monitoring details to be abstracted and generalized in a monitoring policy such that substantially any type of monitoring tool can execute the policy while mitigating the need for custom monitor configurations and code to implement the policy. In one example, an application model can include application parameters and database parameters that describe various properties for an application to execute in a cloud environment. A platform model similarly can describe platform parameters for the cloud including computing resources to provide the underlying computing support for the cloud environment. A topology model can provide linking structures that link the application parameters with the platform parameters, wherein such linking structures can be employed to generate the monitoring policy (e.g., policy generated to monitor e-mail traffic for server 1 operating application 1 which is a mail server application). Such monitoring policy can be described in terms of abstract functionality that enable different monitoring tools to implement the policy yet in accordance with the architectural nuances of the given tool. By generating abstract specifications for monitoring policy, applications and platforms can be ported across various cloud infrastructures while supporting different monitoring tools for each environment, if desired. The abstract specifications provided by the application model, platform model and topology model thus simplify monitoring requirements by mitigating the need to apply custom monitoring code for a given cloud configuration.

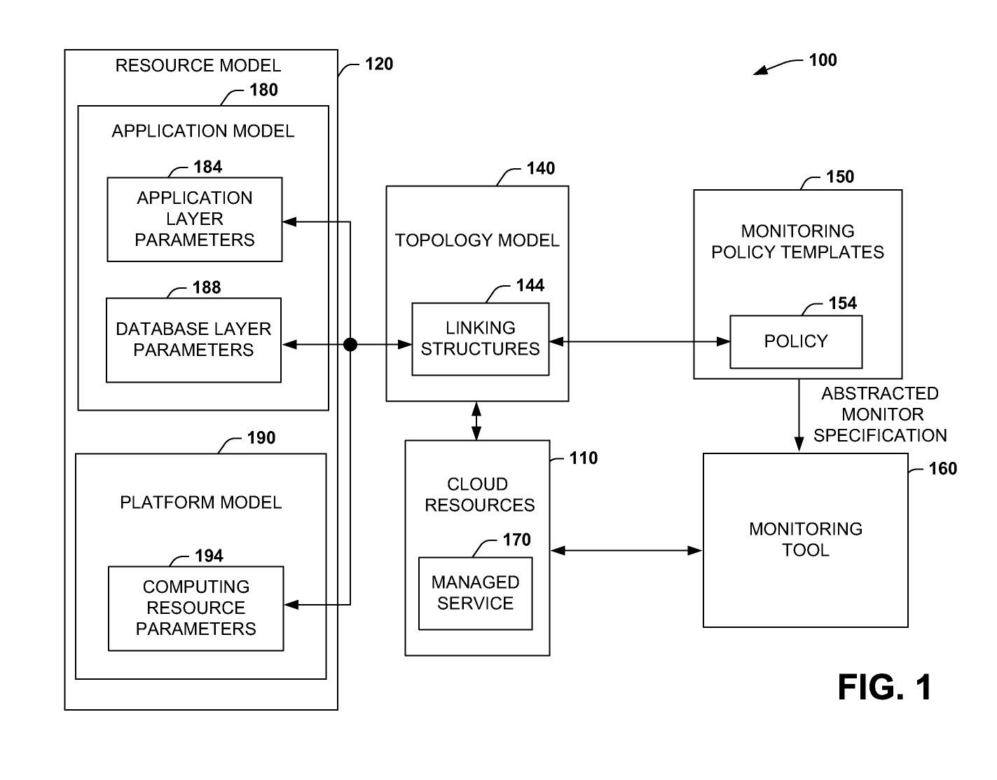

FIG. 1 illustrates an example of a system 100 that facilitates monitoring for managed services via various abstraction models. The system 100 provides a model-driven approach to development/operations collaboration, application deployment automation, and monitoring within cloud resources 110. As used herein, cloud resources 110 (interchangeably referred herein to as a cloud, cloud infrastructure, or cloud environment) can be hardware and software components that support a given cloud configuration including servers and databases, for example. The term “cloud” can also refer to a hybrid such that it can be a combination of traditional data centers that are made to behave like infrastructure resources, private clouds (cloud technology developed on premise), public clouds (offered by service providers and managed cloud configurations (managed on premise or in a public cloud/virtual private cloud). The system 100 provides a centralized structure for implementing a development and standardizes the integration of tools best suited to drive software/service delivery processes.

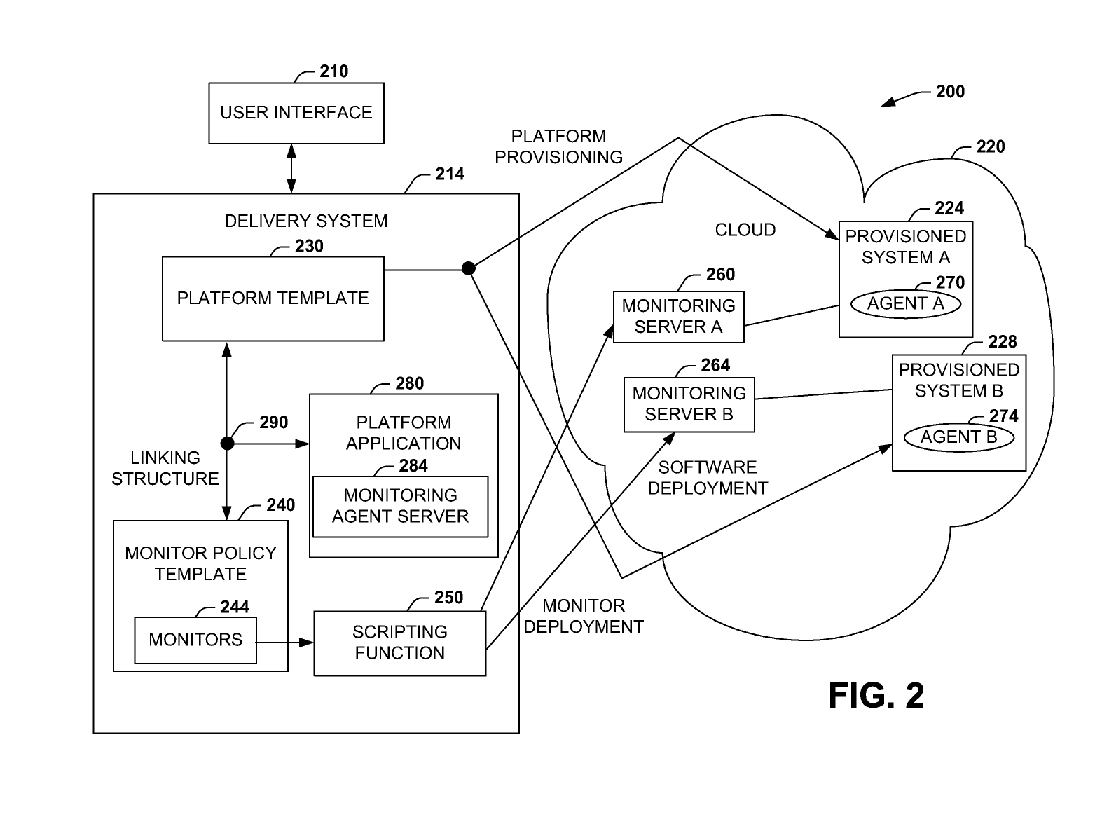

The system 100 facilitates deployment and configuration of an open set of proprietary and 3rd party monitoring collectively and/or concurrently during infrastructure provisioning and application deployment. The model-driven approach of the system 100 mitigates the problems where consumers are limited to a cloud provider's proprietary monitoring and/or a limited set of supported 3rd party monitoring, forcing them to port existing monitoring solutions to those monitoring tools supported by the provider. Additionally, the system 100 allows consumers to deploy both monitoring agents and configurations in a discrete step along with system provisioning and/or application deployment as provided by the model-driven approach of the system 100. Examples of such agents and deployments are illustrated and described below with respect to FIG. 2.

The system 100 includes a resource model 120 that includes application parameters and computing resource parameters that describe how an application and platform are implemented on the cloud resources 110. A topology model 140 includes linking structures 144 that link the application parameters and the computing resource parameters to describe a topology for the application and the platform on the cloud resources 110. The linking structures 144 can include data structures such as file elements or metadata to perform the link. For example, file element 1 describes server A as computing resource which implements operating system B as application operating on the computing resource. As used herein, a topology can describe a physical topology (e.g., a given configuration of cloud resources) and/or can describe a logical topology (e.g., a given configuration of components operating on the cloud resources). A monitoring policy template 150 can include a policy 154 based on the linking structures 144 in the topology model 140, wherein the policy can be employed as an abstracted specification for monitoring the topology for the application and the platform on the cloud resources 110.

A monitoring tool 160 can utilize the abstracted monitor specification in the policy 154 to deploy monitors on the cloud resources 110 yet according to the language-specific nuances of the given tool. For example, the policy 154 may state that an e-mail server needs to be monitored on server A for a threshold number of e-mails processed in a given time period such as per hour or per day. The monitoring tool 160 can then implement monitors (via monitoring servers or agents) to monitor server A for e-mail traffic yet utilize monitoring functions that are provided by the respective tool (e.g., in a language of the monitoring tool but implemented according to the abstract specification in the policy). As shown, the monitoring tool can monitor the cloud resources 110 and/or a managed service 170 operating on the cloud resources. The managed service 170 can be executable in a cloud computing environment and serviced by a service provider who manages the cloud resources 110.

As shown, the resource model 120 can include an application model 180 that stores the application parameters, wherein the application parameters include application layer parameters 184 to describe application requirements and database layer parameters 188 to describe database requirements. In one example, the application parameters 184 can specify an application type to be installed on a server, an application name, an operating system compatible with the application type, an operating system architecture compatible with the application type, an operating system version compatible with the application type, a database vendor, or a database type. Some example application types can include database servers, file transfer protocol (FTP) servers, web servers, application servers, mail servers, or an application deployed to a messaging platform, for example.

The resource model 120 can include a platform model 190 to store the computing resource parameters 194, wherein the computing resource parameters can specify a server group to service the applications specified by the application parameters, an operating system to operate the server group, or a database add-on to operate in accordance with the database vendor and the database type. The monitoring tool 160 can deploy monitors (e.g., functions to monitor cloud activities or components) in accordance with the monitoring policy template 150 for the application and platform implemented on the cloud resources 110.

The monitoring tool 160 can utilize a monitoring agent to deploy the monitors in accordance with the monitoring policy template 150 for the application and platform implemented on the cloud resources. In one example, the monitoring tool 160 can employ a scripting function that utilizes the monitor template 150 to deploy the monitors on the cloud resources 110. In a further example, the scripting function can be described via a Groovy scripting language or a Python scripting language that utilizes the monitor template 150 to deploy the monitors on the cloud resources 110.

A user interface (illustrated and described below with respect to FIG. 2) can be employed to modify the application layer parameters 184, the computer resource parameters 194, the linking structures 144 in the topology model 140, and to describe the policy 154 in the monitoring policy template 150. The user interface can also be employed to perform platform provisioning, application deployment, and monitor deployment on the cloud resources.

In some examples, the cloud resources 110 can be provided as part of a cloud-based data center with an implementation of cloud services on hosts and storage systems that are dedicated to one or more departments (e.g., for private clouds) or organizations (e.g., for public clouds) that have subscribed to such services. Thus, subscribers can receive the benefits of self-service, scalability, and elasticity, along with additional advantages of control and customization that are possible from dedicated resources. Managers of cloud-based environments first have to gather possible needs of subscribers and then instruct the respective administrators (of servers, networks, and storage) to provision them as demanded. Based on a service request assigned to an administrator, the cloud resources 110 can then be provided to the subscriber.

As a further example, cloud resources 110 provisioned to subscribers should be monitored on a regular basis for a smooth running of the respective data center (e.g., within agreed upon operating parameters such as pursuant a service agreement). To facilitate such operation, an expected clause in service level agreements between a cloud service provider and a subscriber is typically very little downtime and low latency between requests and response. Thus, a cloud service provider should ensure that the data center translates incoming requests into managed services 170 as quickly as possible. This also implies that the data center may have to be available round-the-clock (e.g., 24 hours, 7 days per week). In order to track the utilization of managed services 170, cloud service providers can make use of software such as the monitoring tool 160 that monitor the utilization patterns of the managed services 170. The monitoring can be achieved using agents or without using agents. Generally, monitoring can be performed after service requests are translated into managed services 170 and maintained as long as the subscriptions of the managed services are valid.

A typical managed service 170 can be a realization of one or more servers running the same or different operating systems, for example. The monitoring requirements of such managed service 170 in one example can be to track the utilization ratios of disk, central processing unit (CPU), and memory of the servers in the managed service. The managed service 170 can be realized by implementing the various aspects of the cloud resources 110 such as server, network, physical memory, and permanent storage, for example.

In one example, the system 100 can include an application model 180, corresponding to instructions executable by a processor that includes application parameters (184, 188) that describes how an application is implemented on cloud resources 110. The system 100 can include a platform model 190, corresponding to instructions executable by a processor that includes computer resource parameters 194 that describes how a platform is implemented on the cloud resources 110. The system can include a topology model 140, corresponding to instructions executable by a processor that includes linkage structures 144 that link the application parameters (184, 188) in the application model 180 and the computing resource parameters (194) in the platform model 190 to describe a topology for the application and the platform on the cloud resources 110. The system 100 can include a monitoring policy template 150, corresponding to instructions executable by a processor that includes a policy 154 based on the linkage structures 144 in the topology model 140, wherein the policy is employed as an abstracted specification for monitoring the topology for the application and the platform on the cloud resources 110. The policy 154 can be employed by the system 100 to deploy a monitor on the application or the platform on the cloud resources 110.

For purposes of simplification of explanation, in the example of FIG. 1, different components of the system 100 are illustrated and described as performing different functions. However, one of ordinary skill in the art will understand and appreciate that the functions of the described components can be performed by different components, and the functionality of several components can be combined and executed on a single component. The components can be implemented, for example, computer executable instructions, hardware (e.g., an application specific integrated circuit or a processing unit), or as a combination of both. In other examples, the components could be distributing among remote devices across a network.

FIG. 2 illustrates an example system 200 that employs a model-driven architecture to provision and monitor various cloud resources. The system 200 includes a user interface 210 to interact with a delivery system 214 for configuring models and provisioning resources on a cloud 220. In this example, two systems (or more or less than two) can be provisioned at 224 and 228 and shown as provisioned system A and B, respectively. The delivery system 214 includes a platform template 230 to describe parameters for resources supporting the provisioned systems. A monitor policy template 240 describes monitors 244 that can be deployed on the cloud 220 to monitor the provisioned systems 224 and 228. A scripting function 250 can be utilized to install the monitors 244 on monitoring servers 260 and 264, respectively. The servers can also employ agents 270 and 274 which can be utilized to operate the monitors 244. Such agents 270 and 274 can be provisioned along with a platform application 280 via a monitoring agent server 284 associated with the platform application 280. In another example, the monitoring servers 260 and 264 can monitor the provisioned systems 224 and 228 directly with the monitors 244 and without utilization of the agents 270 and 274. A linking structure 290 (e.g., elements within a topology model) can be employed to describe the monitors 244 within the monitor policy template 244.

Similar to the system 100 described above with respect to FIG. 1, the delivery system 214 can employ application and infrastructure parameterized models, where topologies (specified by linking structures) can be used to bind these models together. For example, an application may be defined with two example layers such as application layer and a database layer, wherein each layer has specific requirements, such as operating system versions, database vendor, and so forth. The platform template 230 can describe a set of computing resources (e.g., a server group with a specific operating system and add-on software such as Linux with Oracle version 11g). The topology model described above then links the application model to a platform template providing the application requirements. For example, linking in the topology model could specify that a given application needed to be operated on at least two servers to support the necessary bandwidth. Such linking could also specify how much memory would be needed to support the given application linked to the specified resources in the topology model. Monitoring is associated at this application and platform model linkage shown at 290.

Due to parameterization of infrastructure and application properties, monitor templates 240 that reference these parameters can be created and grouped into policies and associated with application and infrastructure model linkages. Such parameterization model framework supports abstracting out the monitoring tool specifics in order that substantially any proprietary and 3rd party monitoring tool can be supported. Monitoring policies can be deployed and un-deployed as the application is setup and torn down, for example. If the monitoring requires agents, agents can be installed as the platform is provisioned or application is deployed, for example. Thus, the systems described herein allow a monitoring tool to follow the application wherever it moves within the cloud 220. Therefore, substantially any monitoring tool can be configured and deployed and thereby fully supporting reuse of a customer's existing monitoring solution. Such systems also facilitate migration of monitoring configuration and deployment from one cloud environment to another. Monitoring functions can also be moved across different lifecycle phases. For example, monitoring defined for a development cloud environment can be efficiently ported to production's private cloud.

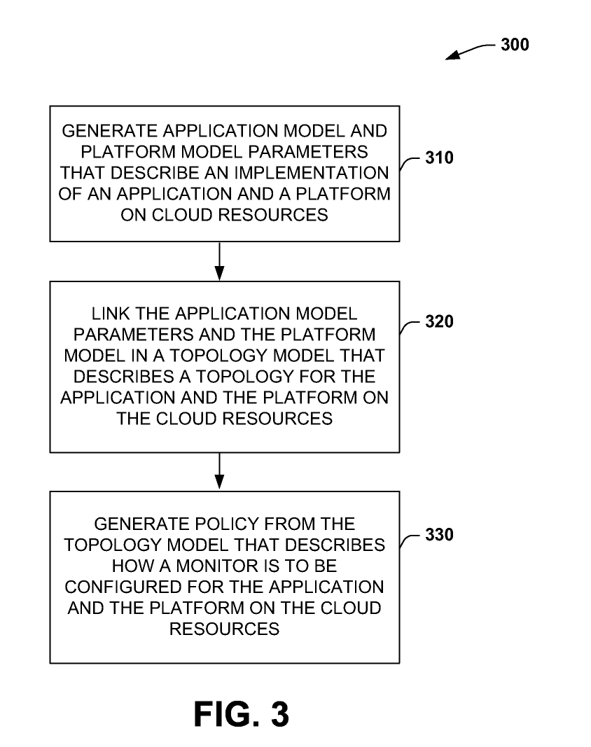

In view of the foregoing structural and functional features described above, example methods will be better appreciated with reference to FIG. 3. While, for purposes of simplicity of explanation, the example method of FIG. 3 is shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method. The example method of FIG. 3 can be implemented as machine-readable instructions that can be stored in a non-transitory computer readable medium, such as can be computer program product or other form of memory storage. The computer readable instructions corresponding to the method of FIG. 3 can also be accessed from memory and be executed by a processor.

FIG. 3 illustrates a flowchart for an example method 300 that facilitates monitoring for managed services via abstraction models. At 310, the method 300 includes generating, by a computer, application model parameters and platform model parameters that describe an implementation of an application and a platform on cloud resources. For example, an application model 180 and platform model 190 described above with respect to FIG. 1 can be employed to generate application model parameters and platform model parameters, respectively. At 320, the method 300 includes linking, by the computer, the application model parameters and the platform model parameters in a topology model that describes a topology for the application and the platform on the cloud resources. Similarly, the topology model 140 shown above with respect to FIG. 1 can be employed to perform the linking. At 330, the method 300 includes generating, by the computer, a monitoring policy from the topology model that describes how a monitor is to be configured for the application and the platform on the cloud resources. Such policy can be generated via a monitoring policy template 150 such as illustrated above with respect to FIG. 1, for example. The method 300 can also include deploying the monitor on the cloud resources in accordance with the topology described in the topology model.

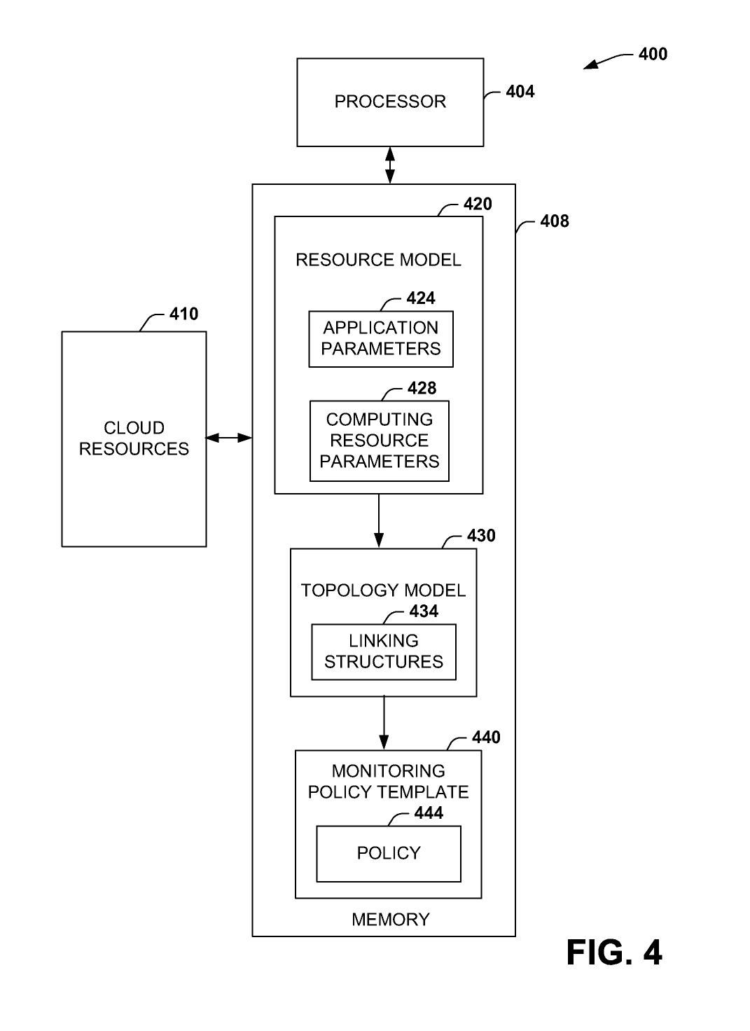

FIG. 4 illustrates an example system 400 for monitoring cloud resources 410 via abstraction models. As shown, the system 400 can include a processor 404 that executes instructions in a memory 408. The memory 408 includes a resource model 420, corresponding to instructions executable by the processor 404, includes application parameters 424 and computing resource parameters 428 that describe how an application and platform are implemented on the cloud resources 410. A topology model 430, corresponding to instructions executable by the processor 404, can include linking structures 434 that link the application parameters 424 and the computing resource parameters 428 to describe a topology for the application and the platform on the cloud resources 410. A monitoring policy template 440, corresponding to instructions executable by the processor 404, can include a policy 444 based on the linking structures 434 in the topology model 430, wherein the policy is employed as an abstracted specification for monitoring the topology for the application and the platform on the cloud resources 410.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
a memory for storing machine-readable instructions; and
a processing unit for accessing the memory and executing the machine-readable instructions, the machine-readable instructions comprising:
a resource model that includes application parameters and computing resource parameters to describe how an application and platform are implemented on cloud resources;
a topology model that includes linking structures to link the application parameters and the computing resource parameters to describe a topology for the application and the platform on the cloud resources; and
a monitoring policy template that includes a policy based on the linking structures in the topology model, wherein the policy is to provide an abstracted specification to enable monitoring the topology for the application and the platform on the cloud resources.

2. The system of claim 1, wherein the resource model includes an application model to store the application parameters, wherein the application parameters include application layer parameters to describe application requirements and database layer parameters to describe database requirements.

3. The system of claim 2, wherein the application parameters specify at least one of an application type to be installed on a server, an application name, an operating system compatible with the application type, an operating system architecture compatible with the application type, an operating system version compatible with the application type, a database vendor, or a database type.

4. The system of claim 3, wherein the application type includes at least one of a database server, a file transfer protocol (FTP) server, a web server, an application server, a mail server, or an application deployed to a messaging platform.

5. The system of claim 3, wherein the resource model includes a platform model to store the computing resource parameters, wherein the computing resource parameters specify a server group to service the application parameters, an operating system to operate the server group, or a database add-on to operate in accordance with the database vendor and the database type.

6. The system of claim 1, further comprising a monitoring tool to deploy a monitor in accordance with the monitoring policy template for the application and platform implemented on the cloud resources.

7. The system of claim 6, wherein the monitoring tool is further programmed to utilize a monitoring agent or a monitoring server to deploy the monitor in accordance with the monitoring policy template for the application and platform implemented on the cloud resources.

8. The system of claim 6, wherein the monitoring tool is further programmed to employ a scripting function that utilizes the monitor template to deploy the monitor on the cloud resources.

9. The system of claim 8, wherein the scripting function is described via a Groovy scripting language or a Python scripting language that utilizes the monitor template to deploy the monitors on the cloud resources.

10. The system of claim 1, further comprising a user interface to modify the application parameters, the computer resource parameters, the linkage structures in the topology model, and to describe the policy in the monitoring policy template.

11. The system of claim 10, wherein the user interface is further to perform platform provisioning, application deployment, and monitor deployment on the cloud resources.

12. A method comprising:
generating, by a computer, application model parameters and platform model parameters to describe an implementation of an application and a platform on cloud resources;
linking, by the computer, the application model parameters and the platform model parameters in a topology model to describe a topology for the application and the platform on the cloud resources; and
generating, by the computer, a monitoring policy based on the topology model that describes how a monitor is to be configured for the application and the platform on the cloud resources.

13. The method of claim 12, further comprising deploying the monitor on the cloud resources in accordance with the topology described in the topology model.

14. A non-transitory machine-readable medium having instructions executable by a processor, the instructions comprising:
an application model that includes application parameters to describe how an application is implemented on cloud resources;
a platform model that includes computer resource parameters to describe how a platform is implemented on the cloud resources;
a topology model that includes linkage structures to link the application parameters in the application model and the computing resource parameters in the platform model to describe a topology for the application and the platform on the cloud resources; and
a monitoring policy template processor that includes a policy based on the linkage structures in the topology model, wherein the policy comprises an abstracted specification to enable monitoring of the topology for the application and the platform on the cloud resources.

15. The machine-readable claim 14, wherein the policy enables monitoring tool to deploy a monitor for the application or the platform on the cloud resources.
